(19) United States
(12) Patent Application Publication
(10) Pub. No.: US 2012/0008497 A1
(43) Pub. Date: Jan. 12, 2012

(54) Method of bandwidth allocation in resilient packet ring network and associated computer-readable storage medium

(75) Inventors: Wen-Shiang Tang, Hsinchu (TW); Chung-Ju Chang, Hsinchu (TW); Wei-Chien Wang, Hsinchu (TW)

(73) Assignee: Loop Telecommunication International, Inc.

(21) Appl. No.: 12/803,799

(22) Filed: Jul. 7, 2010

(51) Int. Cl. H04L 12/24

(52) U.S. Cl. 370/234

(57) ABSTRACT

A method of bandwidth allocation in a Resilient Packet Ring (RPR) network includes: congestion degree of a present node in the RPR network is determined. There is an upstream node and a downstream node of the present node in the RPR network. A present local arrival rate of local traffic flows of the present node from at least one client is obtained. An average transit rate of fairness eligible (FE) flows of the present node in a past time period is calculated. An effective node number for the present node and a present temporal fair rate of the present node are calculated respectively. A present local fair rate of the present node is obtained by looking up a local fair rate table. Transit rate transmitted by the upstream node is controlled according to the present local fair rate of the present node.

### BACKGROUND

1. Technical Field

The present invention relates to a method of bandwidth allocation in a network and a computer-readable storage medium for storing thereof. More particularly, the present invention relates to a method of bandwidth allocation in a Resilient Packet Ring (RPR) network and a computer-readable storage medium for storing thereof.

2. Description of Related Art

The RPR is a ring based network for high-speed metropolitan area networks (MANs) and is constructed by several pairs of two unidirectional links between stations. The RPR has some noticeable properties such as spatial reuse and fair bandwidth allocation to mitigate deficiencies of some MANs, such as SONET and high-speed Ethernet. Also it can achieve high fault tolerance and bandwidth utilization. It is a superior candidate for MANs.

The spatial reuse allows a frame to be removed from the ring at its destination so that the bandwidth on next links can be re-used at the same time. Also, the fair bandwidth allocation avoids stations at upstream transmitting too many low-priority frames to cause system congestion for stations at downstream. RPR needs a congestion control to enhance the fair bandwidth division in the congestion domain, which is defined in the. IEEE 802.17. The congestion control implemented in each station should periodically generate an advertised fair rate to advertise its upstream station for regulating the added fairness eligible (FE) traffic flow defined in IEEE 802.17. The advertised fair rate should be determined referring to the local fair rate, the received fair rate, and the congestion degree of the station. The local fair rate is generated utilizing a fairness algorithm, and the received fair rate is the advertised fair rate from the downstream station.

Two key factors affect performance of the fair bandwidth allocation: congestion detection and fairness algorithm. If the congestion is detected too roughly, it would lower the network's throughput or raise frame loss. In addition, if the propagation delay is large, the short-term arriving transit FE traffic flows would be largely varied and makes the generation of local fair rate unstable. Therefore, there is a need to further improve the local fair rate assignment.

### SUMMARY

According to one embodiment of this invention, a method of bandwidth allocation in an RPR network includes the following steps: congestion degree of a present node in the RPR network is determined, wherein there is an upstream node and a downstream node of the present node in the RPR network, the present node builds connection with the upstream node and the downstream node respectively. A present local arrival rate of local traffic flows received by the present node from at least one client is obtained. An average transit rate of fairness eligible (FE) flows received by the present node from the upstream node in a past time period is obtained. A previous temporal fair rate of the present node is obtained. An effective node number for the present node is calculated according to the average transit rate, the present local arrival rate and the previous temporal fair rate. A present temporal fair rate of the present node is calculated according to the effective node number, the average transit rate and the present local traffic rate. A present local fair rate of the present node is obtained by looking up a local fair rate table according to the congestion degree of the present node and the present temporal fair rate. The present local fair rate is transmitted to the upstream node, such that transit rate transmitted by the upstream node is controlled according to the present local fair rate of the present node.

According to another embodiment of this invention, a computer-readable storage medium for storing a plurality of instructions to execute a method of bandwidth allocation in a RPR network is provided. The method of bandwidth allocation in the RPR network includes the following steps: congestion degree of a present node in the RPR network is determined, wherein there is an upstream node and a downstream node of the present node in the RPR network, the present node builds connection with the upstream node and the downstream node respectively. A present local arrival rate of local traffic flows received by the present node from at least one client is obtained. An average transit rate of FE flows received by the present node from the upstream node in a past time period is obtained. A previous temporal fair rate of the present node is obtained. An effective node number for the present node is calculated according to the average transit rate, the present local arrival rate and the previous temporal fair rate. A present temporal fair rate of the present node is calculated according to the effective node number, the average transit rate and the present local traffic rate. A present local fair rate of the present node is obtained by looking up a local fair rate table according to the congestion degree of the present node and the present temporal fair rate. The present local fair rate is transmitted to the upstream node, such that transit rate transmitted by the upstream node is controlled according to the present local fair rate of the present node.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a block diagram of an RPR network;

FIG. 2 is a block diagram of the node 200 in FIG. 1 according to one embodiment of this invention; and

FIG. 3 is a flow diagram of a method of bandwidth allocation in an RPR network according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

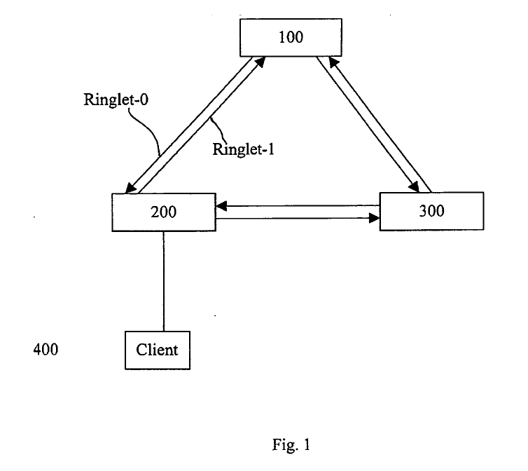

FIG. 1 is a block diagram of an RPR network. The RPR network includes three nodes 100, 200 and 300. The RPR network is constructed by two unidirectional and counter-rotating ringlets, which are named ringlet-0 and ringlet-1. Each of the nodes 100, 200 and 300 is a communication network device and has two pairs of input and output ports to communicate with neighboring nodes. Each of the nodes 100, 200 and 300 has an upstream node and a downstream node on both ringlet-0 and ringlet-1. For example, node 100 and 300 are the upstream node and the downstream node of the node 200 respectively on ringlet-0; node 300 and 100 are the upstream node and the downstream node of the node 200 respectively on ringlet-1. In other embodiments, node number in the RPR network may be varied, which should not be limited in this embodiment.

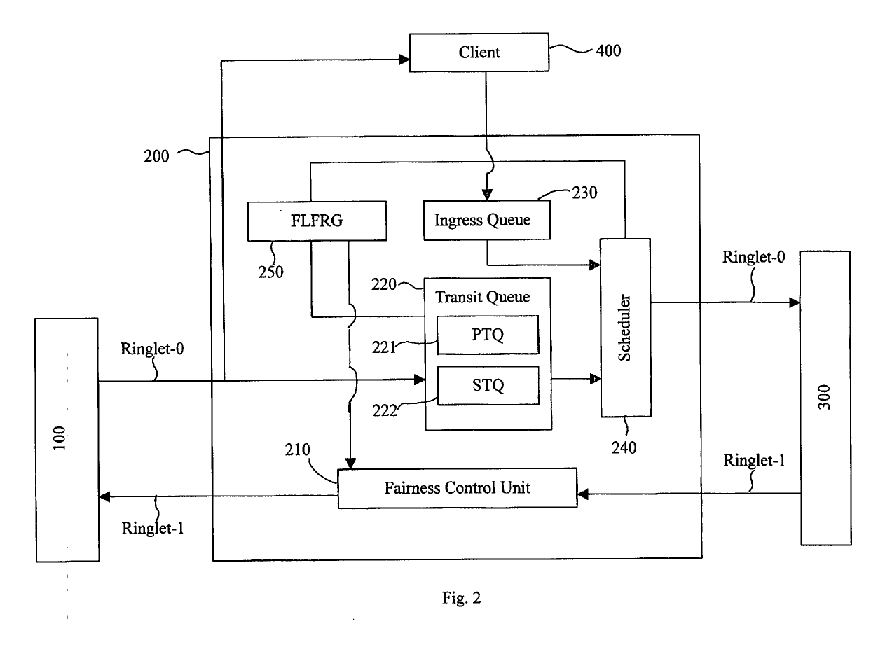

FIG. 2 is a block diagram of the node 200 in FIG. 1 according to one embodiment of this invention. Assume that the node 200 utilizes ringlet-0 to receive and transmit data and utilizes ringlet-1 to receive and transmit signals about fairness rate. Hence, the nodes 100 and 300 are taken as the upstream node and the downstream node of the node 200 respectively. The node 200 includes a fairness control unit 210, a transit queue 220 and an ingress queue 230. The ingress queue 230 buffers local traffic flows received from at least one client 400. The local traffic flows may be divided into classA, classB and classC. The classA is used for real-time services and it has subclassA0 for reserved bandwidth and subclassA1 for reclaimable bandwidth. The classB is targeted for near real-time services, and it also has two subclasses: classB-CIR (committed information rate), which requires the bounded delay and guaranteed bandwidth, and classB-EIR (excess information rate), which does not guarantee bandwidth or delay bound. The classC is intended for best effort services and has the lowest priority. The node 200 only reserves bandwidth for subclassA0, and the remaining bandwidth is provided for other traffic classes according to the order of subclassA1, classB-CIR, classB-EIR and classC. Traffic flows among classB-EIR and classC are defined as the fairness eligible (FE) flows, wherein bandwidth for transiting the FE flows is allocated by a fairness algorithm. The transit queue 220 includes a primary transit queue (PTQ) 221 and secondary transit queue (STQ) 222. The PTQ 221 buffers the transiting classA and classB-CIR frames received from the upstream node 100 for further transition. The STQ 222 buffers the transiting classB-EIR and classC frames (so called FE flows) received from the upstream node 100 for further transition. The node 200 may include a scheduler 240 to decide the transmitting order of data in the transit queue 220 and the ingress queue 230. In addition, the node 200 may include a fuzzy local fair rate generator (FLFRG) 250 to generate a local fair rate periodically utilizing fuzzy set theory. The fairness control unit 210 transmits a fair rate, which is selected from one of the fair rates received from the FLFRG 250 and the downstream node 300, to the upstream node 100 to regulate traffic flows transited from the upstream node 100 through Ringlet-0.

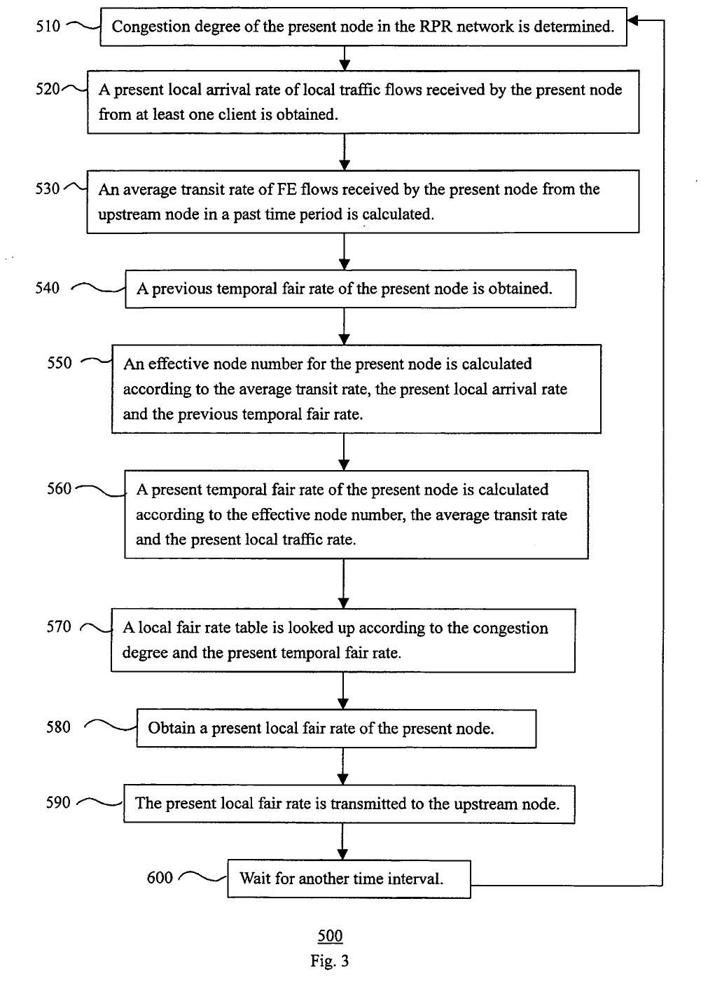

FIG. 3 is a flow diagram of a method of bandwidth allocation in an RPR network according to one embodiment of this invention. In the method of bandwidth allocation in the RPR network, local fair rate of a node of the RPR network are obtained by looking up a local fair rate table according to average transit rate received from its upstream node and its congestion degree. The method of bandwidth allocation in the RPR network may take the form of a computer program product stored on a computer-readable storage medium having computer-readable instructions embodied in the medium. Any suitable computer-readable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives. Assume that the node 200 in FIG. 2 is taken as a present node in the method of bandwidth allocation in the RPR network 300. Referring to FIG. 2 and FIG. 3, the method of bandwidth allocation in the RPR network 500 includes the following steps:

In step 510, congestion degree of the present node 200 in the RPR network is determined. The congestion degree of the present node 200 may be determined based on occupancy of the STQ 222 and a present transit rate of the FE flows received from the upstream node 100. In one embodiment, the congestion degree of the present node may be determined by looking up a congestion degree table according to the occupancy of the STQ and the present transit rate of the FE flows. The congestion degree table may be designed under fuzzy set theory.

TABLE 1

| Rules | Lₛ (n) | Aₛ (n) | D_{c} (n) |
|---|---|---|---|
| 1 | S | L | VL |
| 2 | S | M | VL |
| 3 | S | H | L |
| 4 | L | L | M |
| 5 | L | M | H |
| 6 | L | H | VH |

Table 1 is one embodiment of the congestion degree table designed under fuzzy set theory. In Table 1, Lₛ(n) denotes the occupancy of STQ 222, Aₛ(n) denotes the present transit rate of the FE flows received from the upstream node 100, and D_{c}(n) denotes the congestion degree of the present node 200. The occupancy of STQ 222 Lₛ(n) is classified into Short (S) and Large (L). The present transit rate of the FE flows Aₛ(n) is classified into Low (L), Medium (M) and High (H). The congestion degree of the present node 200 D_{c}(n) is defined as Very Low (VL), Low (L), Medium (M), High (H) and Very High (VH). Hence, the congestion degree of the present node 200 in the RPR network can be determined (step 510) by looking up a congestion degree table according to the occupancy of the STQ and the present transit rate of the FE flows. For example, if the occupancy of STQ 222 Lₛ(n) is S and the present transit rate of the FE flows Aₛ(n) is L, the congestion degree of the present node 200 D_{c}(n) may be determined as VL after looking up Table 1. Therefore, the congestion detection may be more precisely by taking both the occupancy of the STQ 222 and the present transit rate of the FE flows received from the upstream node 100 into consideration. However, the congestion degree table may be designed under another theory, which should not be limited in this disclosure.

In step 520, a present local arrival rate of local traffic flows received by the present node 200 from at least one client 400 is obtained.

In step 530, an average transit rate of the FE flows received by the present node 200 from the upstream node 100 in a past time period is calculated. Wherein, the transit rate of the FE flows received by the present node 200 from the upstream node 100 may be recorded periodically for calculating the average transit rate (step 530). Hence, the average transit rate of the FE flows received by the present node 200 from the upstream node 100 in the past time period may be calculated as follows:

$${\tilde{A}}_{s} ( n ) = {\sum }_{i = n - k + 1}^{n} {A}_{s} ( i ) / k ,$$

wherein Ã\tilde{Aₛ}(n) is the average transit rate calculated from present time n within the past time period k, and Aₛ(i) is transit rate of the FE flows received from the upstream node 100 at time i. Therefore, the propagation delay of traffic flows from further source nodes may be taken into consideration. In addition, since the transit rates in the past time period are taken into consideration, the average transit rate would not vary too much and become more stable.

In step 540, a previous temporal fair rate of the present node 200 is obtained.

In step 550, an effective node number for the present node 200 is calculated according to the average transit rate, the present local arrival rate and the previous temporal fair rate. The effective node number for the present node 200 is number of the nodes transiting data through the present node 200. Since the total transited data are-sum of the transit rate and the local arrival rate, the effective node number for the present node 200 in step 550 may be calculated as follows:

$$M ( n ) = \frac{{\tilde{A}}_{s} ( n ) + {A}_{a} ( n )}{{f}_{p} ( n - 1 )} ,$$

wherein, M(n) is the effective node number at present time n, Ã\tilde{Aₛ}(n) is the average transit rate calculated in step 530, Aₐ(n) is the present local arrival rate at present time n. Hence Ã\tilde{Aₛ}(n)+Aₐ(n) may be taken as total transit rate, which should be transited through the present node 200. fₚ(n-1) is previous temporal fair rate at previous time n-1, which can be taken as the transit rate transited by the effective nodes. Therefore, the effective node number can be calculated by the formula above.

In step 560, a present temporal fair rate of the present node is calculated according to the effective node number, the average transit rate and the present local traffic rate. Wherein, the present temporal fair rate of the present node 200 may be calculated as follows:

$${f}_{p} ( n ) = min \{ C , {f}_{p} ( n - 1 ) + \frac{1}{M ( n )} [ C - ( {A}_{s} ( n ) + {A}_{a} ( n ) ) ] \}$$

wherein fₚ(n) is the present temporal fair rate at present time n, C is available bandwidth of the present node, fₚ(n-1) is the previous temporal fair rate at previous time n-1, M(n) is the effective node number at present time n, Ã\tilde{Aₛ}(n) is the average transit rate and Aₐ(n) is the present local arrival rate at the present time n.

In step 570, a local fair rate table is looked up according to the congestion degree and the present temporal fair rate to obtain a present local fair rate of the present node 200 (step 580). The local fair rate table may be designed under fuzzy set theory.

TABLE 2

| Rule | fₚ(n) | D_{c}(n) | fₗ(n) |
|---|---|---|---|
| 1 | EL | L | PL |
| 2 | EL | M | VL |
| 3 | EL | H | EL |
| 4 | PL | L | SL |
| 5 | PL | M | L |
| 6 | PL | H | PL |
| 7 | SL | L | M |
| 8 | SL | M | SL |
| 9 | SL | H | L |
| 10 | SH | L | H |
| 11 | SH | M | SH |
| 12 | SH | H | M |
| 13 | PH | L | VH |
| 14 | PH | M | PH |
| 15 | PH | H | H |
| 16 | EH | L | EH |
| 17 | EH | M | VH |
| 18 | EH | H | PH |

Table is one embodiment of the local fair rate table designed under fuzzy set theory under fuzzy set theory. In Table 2, fₗ(n) denotes the present local fair rate of the present node 200. The present temporal fair rate fₚ(n) may be classified into Extremely Low (EL), Pretty Low (PL), Slightly Low (SL), Slightly High (SH), Pretty High (PH) and Extremely High (EH). The congestion degree of the present node 200 Dₚ(n) may be Very Low (VL), Low (L), Medium (M), High (H) and Very High (VH). Hence, the obtained present local fair rate of the is present node 200 fₗ(n) may be Extremely Low (EL), Very Low (VL), Pretty Low (PL), Low (L), Slightly Low (SL), Medium (M), Slightly High (SH), High (H), Pretty High (PH), Very High (VH) or Extremely High (EH). Hence, the present local fair rate of the present node 200 fₗ(n) may be obtained (step 580) by looking up the local fair rate table (step 570). For example, if the congestion degree D_{c}(n) determined in step 510 is L and the present temporal fair rate fₚ(n) calculated in step 560 is classified into EL, the present local fair rate of the present node 200 fₗ(n) is PL after looking up Table 2. However, the local fair rate table may be designed under another theory, which should not be limited in this disclosure. Therefore, FLFRG 250 may generate the local fair rate utilizing fuzzy set theory by step 510-step 580.

In step 590, the present local fair rate is transmitted to the upstream node 100 by the fairness control unit 210. Before step 590, the fairness control unit 210 may receive a downstream fair rate from the downstream node 300. The available bandwidth in Rinlet-0 for the present node 200 is defined as full rate of the present node 200. The fairness control unit 210 may select the smallest one from the present local fair rate, the downstream fair rate and the full rate of the present node to be transmitted to the upstream node 100. Then, the upstream node 100 may control its data transition rate according to the received fair rate, which can regulate traffic flows transited from the upstream node 100 through Ringlet-0.

In step 600, wait for another time interval to transmit next present local fair rate utilizing step 510-590. Wherein, the present temporal fair rate of the present node calculated in step 560 may be recorded as the previous temporal fair rate to be obtained (step 540) for calculating next effective node number (step 550).

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of bandwidth allocation in a Resilient Packet Ring (RPR) network, comprising:
determining congestion degree of a present node in the RPR network, wherein there is an upstream node and a downstream node of the present node in the RPR network, the present node builds connection with the upstream node and the downstream node respectively;
obtaining a present local arrival rate of local traffic flows received by the o present node from at least one client;
calculating an average transit rate of fairness eligible (FE) flows received by the present node from the upstream node in a past time period;
obtaining a previous temporal fair rate of the present node;
calculating an effective node number for the present node according to the average transit rate, the present local arrival rate and the previous temporal fair rate;
calculating a present temporal fair rate of the present node according to the effective node number, the average transit rate and the present local traffic rate;
obtaining a present local fair rate of the present node by looking up a local fair rate table according to the congestion degree of the present node and the present temporal fair rate; and
transmitting the present local fair rate to the upstream node, such that transit rate transmitted by the upstream node is controlled according to the present local fair rate of the present node.

2. The method of bandwidth allocation in the RPR network of claim 1, wherein the present node comprises a Secondary Transit Queue (STQ), the STQ buffers the FE flows, and the congestion degree is determined based on occupancy of the STQ and a present transit rate of the FE flows received from the upstream node.

3. The method of bandwidth allocation in the RPR network of claim 2, wherein determining the congestion degree of the present node comprises:
looking up a congestion degree table according to the occupancy of the STQ and the present transit rate of the FE flows to determine the congestion degree of the present node.

4. The method of bandwidth allocation in the RPR network of claim 3, wherein the congestion degree table is designed under fuzzy set theory.

5. The method of bandwidth allocation in the RPR network of claim 1, wherein the average transit rate is calculated by:
$${\tilde{A}}_{s} ( n ) = {\sum }_{i = n - k + 1}^{n} {A}_{s} ( i ) / k ,$$
wherein Ã\tilde{Aₛ}(n) is the average transit rate calculated from present time n within the past time period k, and Aₛ(i) is transit rate of the FE flows received from the upstream node at time i.

6. The method of bandwidth allocation in the RPR network of claim 1, wherein the effective node number is calculated by:
$$M ( n ) = \frac{{\tilde{A}}_{s} ( n ) + {A}_{a} ( n )}{{f}_{p} ( n - 1 )} ,$$
wherein M(n) is the effective node number at present time n, Ã\tilde{Aₛ}(n) is the average transit rate, Aₐ(n) is the present local arrival rate at present time n, fₚ(n-1) is previous temporal fair rate at previous time n-1.

7. The method of bandwidth allocation in the RPR network of claim 1, wherein the present temporal fair rate is calculated by:
$${f}_{p} ( n ) = min \{ C , {f}_{p} ( n - 1 ) + \frac{1}{M ( n )} [ C - ( {A}_{s} ( n ) + {A}_{a} ( n ) ) ] \}$$
wherein fₚ(n) is the present temporal fair rate at present time n, C is available bandwidth of the present node, fₚ(n-1) is the previous temporal fair rate at previous time n-1, M(n) is the effective node number at present time n, Ã\tilde{Aₛ}(n) is the average transit rate and Aₐ(n) is the present local arrival rate at the present time n.

8. The method of bandwidth allocation in the RPR network of claim 1, wherein the local fair rate table is designed under fuzzy set theory.

9. A computer-readable storage medium for storing a plurality of instructions to execute a method of bandwidth allocation in an RPR network, wherein the method of bandwidth allocation in the RPR network comprises:
determining congestion degree of a present node in the RPR network, wherein there is an upstream node and a downstream node of the present node in the RPR network, the present node builds connection with the upstream node and the downstream node respectively;
obtaining a present local arrival rate of local traffic flows received by the present node from at least one client;
calculating an average transit rate of fairness eligible (FE) flows received by the present node from the upstream node in a past time period;
obtaining a previous temporal fair rate of the present node;
calculating an effective node number for the present node according to the average transit rate, the present local arrival rate and the previous temporal fair rate;
calculating a present temporal fair rate of the present node according to the effective node number, the average transit rate and the present local traffic rate; and
obtaining a present local fair rate of the present node by looking up a local fair rate table according to the congestion degree of the present node and the present temporal fair rate; and
transmitting the present local fair rate to the upstream node, such that transit rate transmitted by the upstream node is controlled according to the present local fair rate of the present node.

10. The computer-readable storage medium of claim 9, wherein the present node comprises an STQ, and the STQ buffers the FE flows, and the congestion degree is determined based on occupancy of the STQ and a present transit rate of the FE flows received from the upstream node.

11. The computer-readable storage medium of claim 10, wherein determining the congestion degree of the present node comprises:
looking up a congestion degree table according to the occupancy of the STQ and the present transit rate of the FE flows to obtain the congestion degree of the present node.

12. The computer-readable storage medium of claim 11, wherein the congestion degree table is designed under fuzzy set theory.

13. The computer-readable storage medium of claim 9, wherein the average transit rate is calculated by:
$${\tilde{A}}_{s} ( n ) = {\sum }_{i = n - k + 1}^{n} {A}_{s} ( i ) / k ,$$
wherein Ã\tilde{Aₛ}(n) is the average transit rate calculated from present time n within the past time period k, and Aₛ(i) is transit rate of the FE flows received from the upstream node at time i.

14. The computer-readable storage medium of claim 9, wherein the effective node number is calculated by:
$$M ( n ) = \frac{{\tilde{A}}_{s} ( n ) + {A}_{a} ( n )}{{f}_{p} ( n - 1 )} ,$$
wherein M(n) is the effective node number at present time n, Ã\tilde{Aₛ}(n) is the average transit rate, Aₐ(n) is the present local arrival rate at present time n, fₚ(n-1) is previous temporal fair rate at previous time n-1.

15. The computer-readable storage medium of claim 9, wherein the present temporal fair rate is calculated by:
$${f}_{p} ( n ) = min \{ C , {f}_{p} ( n - 1 ) + \frac{1}{M ( n )} [ C - ( {A}_{s} ( n ) + {A}_{a} ( n ) ) ] \}$$
wherein fₚ(n) is the present temporal fair rate at present time n, C is available bandwidth of the present node, fₚ(n-1) is the previous temporal fair rate at previous time n-1, M(n) is the effective node number at present time n, Ã\tilde{Aₛ}(n) is the average transit rate and Aₐ(n) is the present local arrival rate at the present time n.

16. The computer-readable storage medium of claim 9, wherein the local is fair rate table is designed under fuzzy set theory.
